(19) United States
(12) Patent Application Publication
(10) Pub. No.: US 2026/0012114 A1
(43) Pub. Date: Jan. 8, 2026

(54) OPERATING A HOUSEHOLD APPLIANCE WITH A BLDC DRIVE MOTOR

(71) Applicant: BSH Hausgeräte GmbH, München (DE)

(72) Inventors: Roman MAYER, Burgheim (DE); Markus HOSER, Aislingen (DE); Johannes SCHUSTER, Stuttgart (DE)

(21) Appl. No.: 18/879,911

(22) PCT Filed: Jun. 27, 2023
(86) PCT No.: PCT/EP2023/067362

§ 371 Date: Dec. 30, 2024

(30) Foreign Application Priority Data
Jun. 28, 2022 (DE) 10 2022 206 532.8

(51) Int. Cl. H02P 21/34; F25B 49/02; H02P 21/13; H02P 21/18; H02P 21/26

(52) U.S. Cl. CPC H02P 21/34; F25B 49/025; H02P 21/13; H02P 21/18; H02P 21/26; F25B 2600/0253; H02P 2205/05; H02P 2205/07

(57) ABSTRACT

A method operates a household appliance, in which, in order to start up a BLDC drive motor of the household appliance, an actual rotational speed of a rotor of the BLDC drive motor is increased in a controlled manner from an idle state by a deterministic target control torque, and an actual angle and the actual rotational speed of the rotor are determined by high-frequency injection. In the event that the actual rotational speed reaches or exceeds a first threshold rotational speed, the actual rotational speed is controlled to a target rotational speed. In the event that the actual rotational speed reaches or exceeds a second threshold rotational speed, the actual angle and the actual rotational speed are determined from an EMF signal. Specifically, the method is used for starting up the BLDC drive motor, which drives a reciprocating compressor of a refrigeration circuit of a household refrigeration appliance.

The invention relates to a method for operating a household appliance, in which, in order to start up a BLDC drive motor of the household appliance, an actual rotational speed of a rotor of the BLDC drive motor is increased from its idle state and an actual angle and the actual rotational speed are determined by means of high-frequency injection. The invention also relates to a household appliance with a BLDC drive motor, the household appliance being designed to perform the method. The invention can in particular be advantageously used for starting up a BLDC drive motor, which drives a reciprocating compressor of a refrigeration circuit of a household refrigeration appliance, in particular a refrigerator.

DE 10 2020 203 488 A1 discloses a household appliance and a method for operating a household appliance. The household appliance comprises a component and a controlled electric drive, which has a permanently excited three-phase synchronous motor, an actuator element, designed in particular as a converter, for actuating the three-phase synchronous motor, and a field-oriented control for actuating the actuator element. The three-phase synchronous motor comprises a stator and a rotor which is rotatably mounted in respect of the stator, and is part of the component or is intended for driving said component, having the following method steps: during an operating phase of the electric drive, speed-controlled operation of the controlled electric drive by means of the field-oriented control and as a function of an angular position of the rotor relative to the stator determined by means of the direct and quadrature currents and a mathematical model of the three-phase synchronous motor, and during a braking phase of the electric drive following on from the operating phase, —reducing the speed of the three-phase synchronous motor by speed-controlled operation of the controlled electric drive by means of the field-oriented control and as a function of an angular position of the rotor relative to the stator determined by means of the direct and quadrature currents and a mathematical model of the three-phase synchronous motor, until the speed reaches a predetermined limit speed, —superimposing a high-frequency voltage on a supply voltage generated by the actuator element and intended for the operation of the three-phase synchronous motor, as a result of which phase currents and the direct and quadrature currents of the three-phase synchronous motor have corresponding high-frequency current components, —determining high-frequency current components of the direct and quadrature currents, —determining the angular position of the rotor relative to the stator as a function of the high-frequency current components of the direct and quadrature currents, and —further reducing the speed of the three-phase synchronous motor by speed-controlled operation of the controlled electric drive by means of the field-oriented control and as a function of the angular position of the rotor relative to the stator determined by means of the high-frequency current components of the direct and quadrature currents.

DE 10 2020 203 489 A1 discloses a household appliance and a method for operating a household appliance. The household appliance comprises a component and a controlled electric drive, which has a permanently excited three-phase synchronous motor, an actuator element, designed in particular as a converter, for actuating the three-phase synchronous motor, and a field-oriented control for actuating the actuator element. The three-phase synchronous motor comprises a stator and a rotor which is rotatably mounted in respect of the stator and is part of the component or is intended to drive said component, having the following method steps: during a startup phase of the electric drive, —superimposing a high-frequency voltage on a supply voltage generated by the actuator element and intended for the operation of the three-phase synchronous motor, as a result of which phase currents of the three-phase synchronous motor have corresponding high-frequency current components, —determining direct and quadrature currents assigned by the three-phase synchronous motor from the phase currents, which have high-frequency current components corresponding to the high-frequency voltage, —determining the angular position of the rotor relative to the stator as a function of the high-frequency current components of the direct and quadrature currents, and —increasing the speed of the three-phase synchronous motor by speed-controlled operation of the controlled electric drive by means of the field-oriented control and as a function of the angular position of the rotor relative to the stator determined by means of the high-frequency current components of the direct and quadrature currents until the three-phase synchronous motor reaches a predetermined limit speed, and, during an operating phase subsequent to the startup phase, speed-controlled operation of the controlled electric drive by means of the field-oriented control and as a function of an angular position of the rotor relative to the stator determined by means of the direct and quadrature currents and a mathematical model of the three-phase synchronous motor.

For example, it is known from DE 10 2016 210 443 A1 or DE 10 2017 213 069 A1 for a high-frequency voltage to be superimposed on the supply voltage of a three-phase synchronous motor, which causes a corresponding superimposed high-frequency component of the phase currents of the three-phase motor to determine the angular position of the rotor relative to the stator of the three-phase motor.

It is the object of the present invention to overcome the disadvantages of the prior art at least in part and in particular to provide an opportunity to perform a startup or shutdown of a BLDC drive motor of a reciprocating compressor of a household appliance more gently for mechanical components of the household appliance and more quietly, in particular to reduce a “knocking noise”.

This object is achieved in accordance with the features of the independent claims. Preferred forms of embodiment can in particular be taken from the dependent claims.

The object is achieved by a method for operating a household appliance, specifically for starting up a BLDC drive motor of the household appliance, in which
an actual rotational speed, ω, of a rotor of the BLDC drive motor is increased in a controlled manner from its idle state by means of a deterministic target control torque, and an actual (positional) angle, e, and the actual rotational speed ω of the rotor are determined by means of high-frequency injection, HFI,
in the event that the actual rotational speed ω reaches or exceeds a predetermined first threshold rotational speed, the actual rotational speed ω is controlled to a target rotational speed ω_{ref} and
in the event that the actual rotational speed ω reaches or exceeds a predetermined second threshold rotational speed, the actual angle θ and the actual rotational speed ω are determined by means of EMF.

This method has the advantage that because the positional angle or the angular position are known precisely when using the HFI method even at a low actual rotational speed ω an effective utilization of the actuating torque is possible, because in this way the torque can be ensured. As a result, the startup of the BLDC drive motor can be performed more gently for the mechanical components of the household appliance. The probability of knocking noise occurring is also minimized in this way. This takes advantage of the fact that the HFI method can determine the actual angle θ and the actual rotational speed ω with sufficient accuracy as from speed ω zero.

The fact that at higher actual rotational speeds a switch is made from the HFI method to the EMF method has the advantage that disadvantages, which occur at higher actual rotational speeds, of determining the actual angle and the actual rotational speed by means of high-frequency injection are avoided. Thus at higher actual rotational speeds it can for example happen that the computing power is not sufficient to calculate the actual angle and the actual rotational speed in a timely manner.

The household appliance can be a refrigeration device, for example a refrigerator, a freezer or a combination thereof. The household appliance can be a laundry treatment appliance, for example a washing machine, a tumble dryer or a combination thereof (washer-dryer). The household appliance can however also be a dishwasher, for example.

A “BLDC drive motor” is understood in particular as a brushless direct-current motor, which is intended, i.e. arranged and designed, to drive a further component of the household appliance. In particular, a rotor of the BLDC drive motor can serve as a drive shaft.

The startup can also be referred to as a start or starting. In one embodiment, in the idle state of the BLDC drive motor its actual rotational speed ω is zero, i.e. the BLDC drive motor is started up from standstill.

The “deterministic” target control torque is in particular a target control torque which is not generated by a control, but is calculated from measured data or stored data and/or is read out from a data memory, for example by means of at least one characteristic curve or by means of table values. The deterministic target control torque can be parameterized, i.e. it is output as a function of at least one parameter.

The fact that the actual rotational speed is increased in a controlled manner by means of the deterministic target control torque means in particular that the deterministic target control torque is provided as an input variable or default of a control. This can in particular be a torque control.

With high-frequency injection, a high-frequency voltage is superimposed on a supply voltage of the BLDC drive motor, and causes a corresponding superimposed high-frequency component of the phase or motor currents of the BLDC drive motor to determine the actual angle of the rotor relative to the stator of the BLDC drive motor. The actual angle can also be referred to as the actual positional angle or actual angular position. The actual rotational speed of the rotor can be determined from the actual angle.

The fact the actual rotational speed is controlled to a target rotational speed means in particular that a target control torque is output as a manipulated variable of a speed controller. When a first speed threshold value (the first “threshold rotational speed”) is reached a switch is thus made from control by means of the deterministic target control torque to control in which the target control torque is generated by means of a speed control.

The fact that, then, in the event that the actual rotational speed reaches or exceeds a predetermined second threshold rotational speed the actual angle and the actual rotational speed are determined by means of EMF means in particular that when a second speed threshold value (the second “threshold rotational speed”) is reached a switch is made from determining the actual angle and the actual rotational speed by means of high-frequency injection or a high-frequency injection method to determining the actual angle and the actual rotational speed by means of EMF (“Electromotive Force”) or an EMF method. EMF can also be referred to as BEMF (“Back Electromotive Force”).

In one development, the HFI method and/or the (“Electromotive Force”) method can be implemented in corresponding observers. The observers can for example be designed as Luenberger, Kalman, etc. observers or can have Luenberger, Kalman, etc. observers.

In one embodiment, the second threshold rotational speed is greater than the first threshold rotational speed, so that chronologically a switch is first made to speed control and then to determination of the actual angle and the actual rotational speed by means of EMF. However, the method is not restricted to this, but the second threshold rotational speed can also be less than the first threshold rotational speed. In one development, the first threshold rotational speed also corresponds to the second threshold rotational speed.

A value which corresponds to the physical meaning of a torque can be used as the target control torque. Alternatively, at least one value can be used as the target control torque, which analogously maps the physical meaning of a torque in relation to the motor, for example target currents in the direct/quadrature system. Consequently, a torque value or, equivalent thereto, the setpoint currents in the direct/quadrature system can for example be output as a deterministic target control torque.

In one embodiment, control signals for energizing coils of the BLDC drive motor are generated by means of a field-oriented control from a target control torque and the actual angle, wherein
if the actual rotational speed has not yet reached or exceeded the first threshold rotational speed, the target control torque supplied to the field-oriented control is the deterministic target control torque and
if the actual rotational speed ω reaches or exceeds the first threshold rotational speed, the target control torque supplied to the field-oriented control is a manipulated variable of a speed control, whose reference variable corresponds to the target rotational speed and whose feedback variable corresponds to the actual rotational speed.

The field-oriented control (FOC) can comprise a space vector pulse width modulation (space vector PWM, SVPWM). The field-oriented control in particular uses target currents in the d/q system as target variables, specifically a target I_{d} current and a target I_{q} current. These target currents in the d/q system can be calculated from the target control torque and can correspond highly accurately to the target control torque. The target currents in the d/q system can thus be regarded as representatives of the target control torque in the d/q system. In one development, the field-oriented control outputs measured or internally calculated variables as measured variables for observers, for example measured motor currents and/or voltages and/or currents in a robot-related α/β system.

In one embodiment, the deterministic target control torque is generated by means of a signal transmitter. The signal transmitter generates an output signal corresponding to the deterministic target control torque on the basis of values that are input, for example values calculated via a formula or retrieved from a data memory. The signal transmitter is in particular not a control and can therefore also be referred to as a “control-free” signal transmitter.

In one embodiment, the deterministic target control torque is a constant target control torque. This can advantageously be implemented particularly easily.

In one embodiment, the deterministic target control torque is a chronological progression of the target control torque or has more than two chronologically consecutive, different values. This has the advantage that the startup can be performed particularly smoothly.

In one embodiment, the deterministic target control torque is dependent on at least one pressure present in a reciprocating compressor of the household appliance driven by the BLDC drive motor or a variable derived therefrom, for example a pressure ratio. Thus the target control torque can advantageously be adapted specifically to the pressure or pressures in the reciprocating compressor and thus to the expected load pressures. This in turn enables a particularly smooth startup. A further advantage of the method when used with a reciprocating compressor is that “sticking” at the first compression is prevented during startup in accordance with the deterministic target control torque, even under high load conditions.

In one embodiment, an MTPA (“Maximum Torque per Ampere”) logic is connected upstream of the field-oriented control logic, and converts the target control torque into a target I_{d} current and a target I_{q} current and can transfer it as input variables for example to the field-oriented control logic. This is advantageous in order to operate the BLDC motor particularly effectively based on the target control torque. For the same purpose, in one development a field weakening logic is integrated into the MTPA logic.

In one embodiment, a reciprocating compressor is or can be driven by means of the BLDC drive motor. The method can be used for this particularly advantageously, because in this case there is a particularly high probability that components of the household appliance are subject to mechanical stress during startup and knocking noise can occur.

In one development, the reciprocating compressor is a component of a refrigeration circuit. Then in one embodiment the household appliance is a refrigeration appliance, for example a refrigerator, a freezer or a combination thereof.

In one development, the reciprocating compressor is a component of a heat pump. In particular, in this case the household appliance can for example be a laundry treatment appliance such as a washing machine, a tumble dryer or a combination thereof (a washer-dryer). However, the household appliance can also be a dishwasher.

In one development, a laundry drum of a laundry treatment appliance is or can be driven by means of the BLDC drive motor.

The object is also achieved by a household appliance with a BLDC drive motor, wherein the household appliance is designed to perform the method as described above. The household appliance can be designed analogously to the method, and vice versa, and has the same advantages.

Thus the household appliance can for example be a refrigeration device, in which a compressor, in particular a reciprocating compressor, of a refrigeration circuit can be driven by means of the BLDC drive motor.

In one development, the BLDC drive motor can be actuated by means of a converter circuit and the converter circuit is designed to perform the method.

The above-described properties, features and advantages of this invention and the way in which they are achieved will become clearer and more readily comprehensible in connection with the following schematic description of an exemplary embodiment, which is explained in greater detail in connection with the drawings.

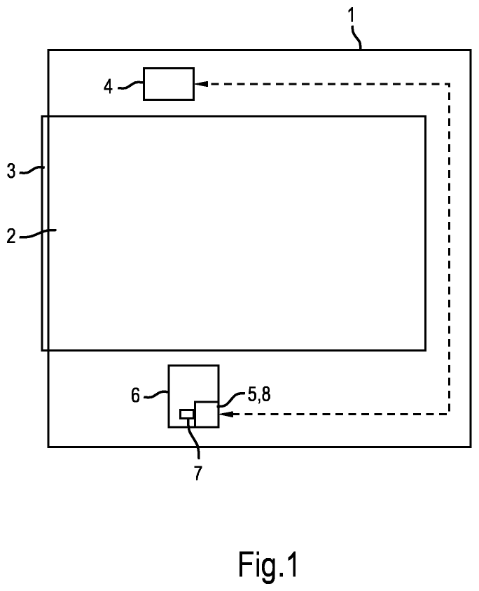

FIG. 1 shows, as a sectional view from the side, a sketch of a household appliance in the form of a refrigerator;

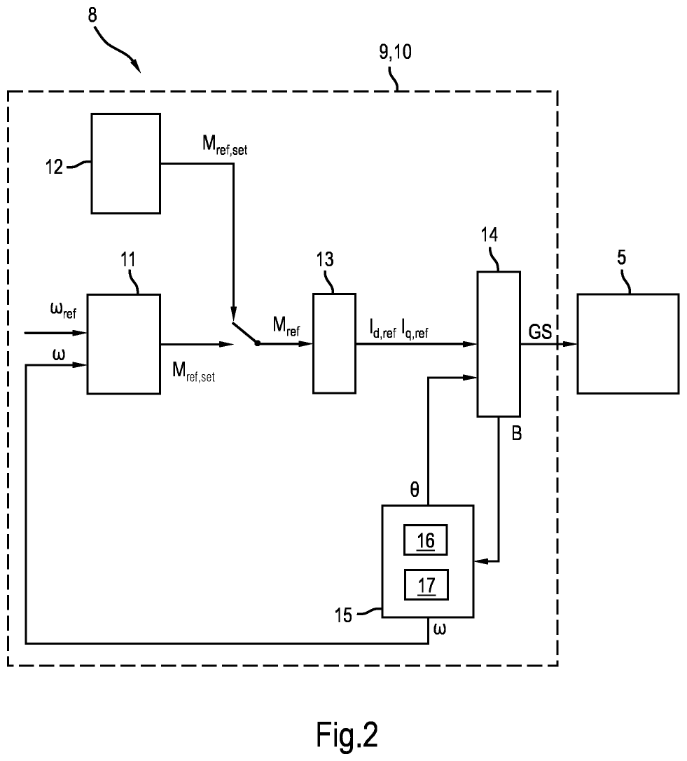

FIG. 2 shows one possible functional structure of a motor control for driving a drive motor of the household appliance from FIG. 1;

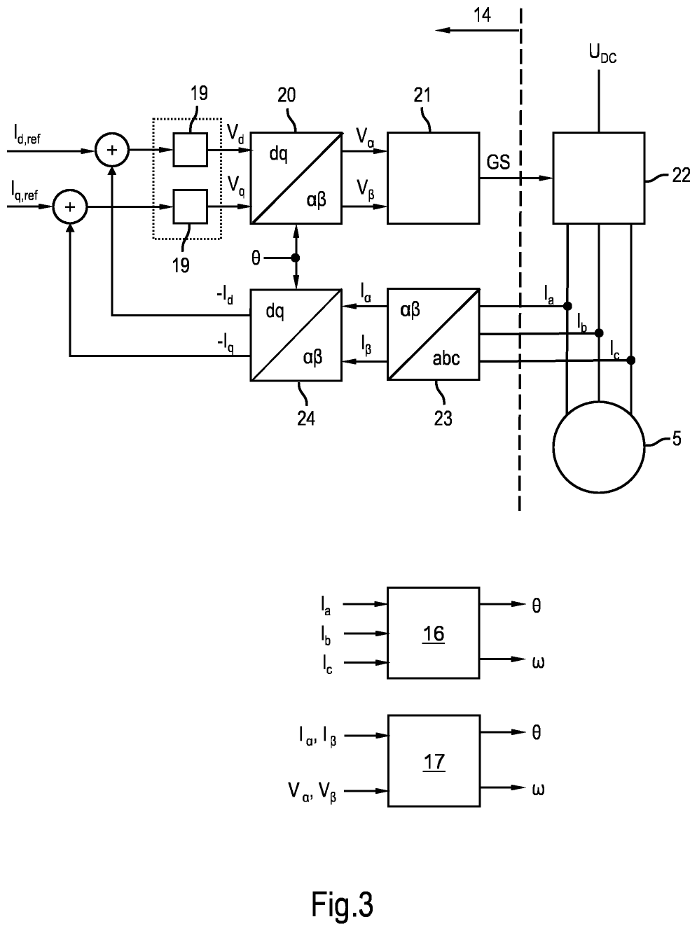

FIG. 3 shows in greater detail one possible functional structure of a field-oriented control of the motor control from FIG. 2;

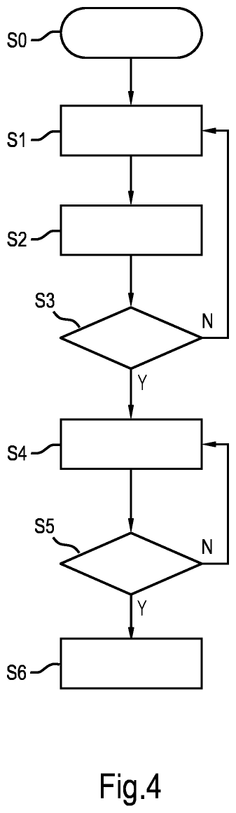

FIG. 4 shows one possible operational sequence of a method for starting the drive motor.

FIG. 1 shows, as a sectional view from the side, a sketch of a household appliance in the form of a refrigerator 1. The refrigerator 1 has a refrigeration compartment 2, whose front loading opening can be closed by means of a door 3. The refrigerator 1 is controlled by means of a control device 4. In one development, the control device 4 can actuate a BLDC drive motor 5 of a compressor 6 of a refrigeration circuit. The compressor 6 is here designed as a reciprocating compressor. The BLDC drive motor 5 has a rotor 7 serving as a drive shaft and can be actuated by means of a motor control 8, which generates actuation signals for energizing coils of the BLDC drive motor 5. The motor control 8 can be a component of the BLDC drive motor 5, for example integrated in a converter circuit 9 of the BLDC drive motor 5 in terms of hardware and/or software, in particular in a controller 10 of the converter circuit 9, see FIG. 2. Alternatively, the converter circuit 9 or the entire motor control 8 can also be integrated in the control device 4 of the refrigerator 1.

FIG. 2 shows one possible functional structure of the motor control 8 on the basis of different functional blocks.

One of the functional blocks is a speed control 11, which calculates a target control torque M_{ref,set} as a manipulated variable on the basis of a target rotational speed ω_{ref} and an actual rotational speed ω of the rotor 7.

Another of the functional blocks is a signal transmitter 12, which—regardless of the actual rotational speed ω—outputs a deterministic target control torque M_{ref,det}. This deterministic target control torque M_{ref,det} can be constant or can be a chronological progression. In particular, the deterministic target control torque M_{ref,det} can be parameterized.

An MTPA logic 13, which can also comprise a field-weakening logic, calculates an equivalent pair from target I_{d} current I_{d,ref} and target I_{q} current I_{q,ref} in the d/q system on the basis of an input target control torque M_{ref} and transfers these values to a field-oriented control 14. The target control torque M_{ref} which is input into the MTPA logic 13 is, as indicated schematically by the switch symbol, optionally either the target control torque M_{ref,set} output by the speed control 11 or the deterministic target control torque M_{ref,det} output by the signal transmitter 12.

The field-oriented control 14 calculates the actuation signals for energizing the coils of the BLDC drive motor 5 from the target I_{d} current I_{d,ref}, from the target I_{q} current I_{q,ref} and from an actual angle θ of the rotor 7.

The motor control 8 further comprises an observer 15, for example a Luenberger observer, which receives input variables or measured variables B from the field-oriented control 14 and calculates or estimates therefrom the actual angle θ and the actual rotational speed ω of the rotor 7. The actual angle θ is transferred to the field-oriented control 14, while the actual rotational speed ω is transferred to the speed control 11.

The observer 15 here comprises an HFI (high-frequency injection) observer 16, which determines, in particular estimates, the actual angle θ and the actual rotational speed ω from measured variables B in the form of motor currents, which have a high-frequency component generated by high-frequency injection. The observer 15 further comprises an EMF observer 17, which uses EMF to determine, in particular estimate, the actual angle θ and the actual rotational speed ω from measured variables B in the form of transformed measured motor currents and motor voltages calculated in the field-oriented control 14.

FIG. 3 shows one possible detailed embodiment of the field-oriented control 14 and the observers 16 and 17.

Firstly a difference is formed from the target I_{d} current I_{d,ref} and an actual I_{d} current I_{d} supplied by the MTPA logic 13, as well as analogously a difference between target I_{q} current I_{q,ref} and actual I_{q} current I_{q}. The differences are supplied to respective controllers 19, for example PI controllers. The controllers 19 can also be referred to as current control. The controllers 19 emit a voltage V_{d} or V_{q}, which are transferred to an inverse Park transformation 20.

The inverse Park transformation 20 calculates voltages V_{α} and V_{β} in the α/β system from the voltages V_{d} and V_{q} and the actual angle θ and transfers them to a space vector PWM 21 (SVPWM). The space vector PWM 21 generates actuation signals GS, for example gate signals for transistors, for an H-bridge 22, which need no longer be part of the field-oriented control 14. The H-bridge 22 energizes the BLDC drive motor 5 in accordance with the actuation signals GS.

The field-oriented control 14 further comprises a Clarke transformation 23, which converts the measured motor currents Iₐ, I_{b}, I_{c} into currents I_{α}, I_{β} in the α/β system, which in turn are converted into the actual I_{d} current I_{d} and the actual I_{q} current I_{q} by means of a Park transformation 24 with knowledge of the actual angle θ. The blocks 23 and 24 can jointly also be referred to as Clarke-Park transformation. The actual I_{d} current I_{d} and the actual I_{q} current I_{q} are fed back with the target I_{d} current I_{d,ref} or the target I_{q} current I_{q,ref} for calculation of the difference.

The HFI observer 16 receives the motor currents Iₐ, I_{b}, I_{c} still subject to high frequency from the field-oriented control 14 as measured variables B and estimates therefrom the actual angle θ and the actual rotational speed ω of the rotor 7. In one development, the HFI observer 16 can comprise a Luenberger, Kalman, etc. observer.

The EMF observer 17 receives the currents I_{α}, I_{β} in the α/β system and the voltages V_{α}, V_{β} in the α/β system from the field-oriented control 14 as measured variables B and therefrom estimates the actual angle θ and the actual rotational speed ω of the rotor 7. In one development, the EMF observer 17 can be designed as a Luenberger, Kalman, etc. observer.

FIG. 4 shows one possible exemplary embodiment for how the motor control 8 can perform a startup of the BLDC drive motor 5:

It may be assumed that the BLDC drive motor 5 is in its idle state in a step S0, in which its actual rotational speed ω is zero, for example because it is not energized.

In a step S1, HFI signals are impressed on the motor currents Iₐ, I_{b}, I_{c} and the motor currents Iₐ, I_{b}, I_{c} are assigned to the BLDC drive motor 5. By means of the HFI observer 16 the actual angle θ and the actual rotational speed ω of the rotor 7 are determined, in particular cyclically, for example with a cycle duration T_{A} of approx. 250 μs. In this case it is advantageous that by means of the method of high-frequency injection ω=0 is also apparent.

In step S2 the deterministic target control torque M_{ref,det} is generated by means of the signal transmitter 12, i.e. M_{ref}=M_{ref,det} applies, and is output to the MTPA logic 13. Thus the target I_{d} current I_{d,ref} and the target I_{q} current I_{q,ref} are calculated and are transferred to the field-oriented control 14. As already described above, the field-oriented control 14 generates the actuation signals GS therefrom and from the actual angle θ estimated by the HFI observer 16 and also outputs the measured variables B for the HFI observer 16.

In step S3 a check is made to see whether the actual rotational speed ω determined by means of the HFI observer 16 has reached or exceeded a first threshold value, namely the first threshold rotational speed. If not (“N”), a return is made to step S1.

The speed control 11 is not used in steps S1 to S3.

If yes (“Y”), the system proceeds to step S4, in which the deterministic target control torque M_{ref,det} generated by means of the signal transmitter 14 is now no longer output to the MTPA logic 15, but the target control torque M_{ref,set} calculated by the speed control 11, i.e. M_{ref}=M_{ref,set} applies.

Analogously to step S2, the MTPA logic 13 calculates the target I_{d} current I_{d,ref} and the target I_{q} current I_{q,ref} from M_{ref}=M_{ref,set} and transfers them to the field-oriented control 14, which therefrom both generates the actuation signals GS from the actual angle θ estimated by the HFI observer 16 and outputs the measured variables B for the HFI observer 16.

In step S5, a check is made to see whether the actual rotational speed ω determined by means of the HFI observer 16 has reached or exceeded a second threshold value, namely the second threshold rotational speed. If not (“N”), the system returns to step S4. However, if this is the case (“Y”), the system proceeds to step S6.

In step S7, the actual angle θ and the actual rotational speed ω are now determined by means of the EMF observer 17, but the procedure is otherwise analogous to step S4.

The present invention is not of course restricted to the exemplary embodiment shown.

Thus in the exemplary embodiment described in FIG. 4 it is assumed that the second threshold rotational speed is greater than the first threshold rotational speed. However, the first threshold rotational speed can alternatively be greater than the second threshold rotational speed, or both the threshold rotational speeds are the same.

It is also possible to dispense with the MTPA logic 13. In this case either the target I_{d} current I_{d,ref} and the target I_{q} current I_{q,ref} can be calculated from the target control torque M_{ref} by means of other calculation rules or can be converted in the field-oriented control 14 or output directly by the speed controller 11 and the signal transmitter 12.

In addition, the actual angle θ and/or the actual rotational speed ω can be determined by means of a sensor instead of an observer 15, for example by means of at least one Hall sensor installed in the BLDC drive motor 5.

In general, “one”, “a” etc. may be understood as a singular or a plural, in particular in the sense of “at least one” or “one or more”, etc., providing this is not explicitly excluded, for example by the expression “exactly one”, etc.

Also, a number specified may comprise exactly the specified number as well as a usual tolerance range, providing this is not explicitly excluded.

### LIST OF REFERENCE CHARACTERS

1 Refrigerator
2 Refrigeration compartment
3 Door
4 Control device
5 BLDC drive motor
6 Compressor
7 Rotor
8 Motor control
9 Converter circuit
10 Controller
11 Speed control
12 Signal transmitter
13 MTPA logic
14 Field-oriented control
15 Observer
16 High-frequency injection observer
17 EMF observer
19 PI controller
20 Inverse Park transformation
21 Space vector PWM
22 H-bridge
23 Clarke transformation
24 Park transformation
B Measured variable
GS Actuation signals
Iₐ, I_{b}, I_{c} Motor currents
I_{d} Actual I_{d} current
I_{q} Actual I_{q} current
I_{d,ref} Target I_{d} current
I_{q,ref} Target I_{q} current
M_{ref} Target control torque
M_{ref,det} Deterministic target control torque
M_{ref,set} Target control torque
S0-S6 Method steps
V_{α} Voltage in the α/β system
V_{β} Voltage in the α/β system
V_{d} Voltage in the d/q system
V_{q} Voltage in the d/q system
ω Actual rotational speed
ω_{ref} Target rotational speed
θ Actual angle

1-12. (canceled)

13. A method for operating a household appliance, which comprises the steps of:
starting up a brushless direct current (BLDC) drive motor of the household appliance by the further sub-steps of:
increasing an actual rotational speed of a rotor of the BLDC drive motor in a controlled manner from its idle state by means of a deterministic target control torque;
determining an actual angle and the actual rotational speed of the rotor by means of high-frequency injection;
controlling the actual rotational speed to a target rotational speed in an event that the actual rotational speed reaches or exceeds a first threshold rotational speed; and
determining the actual angle and the actual rotational speed from an electromagnetic field (EMF) signal in an event that the actual rotational speed reaches or exceeds a second threshold rotational speed.

14. The method according to claim 13, wherein the second threshold rotational speed is greater than the first threshold rotational speed.

15. The method according to claim 13, which further comprises generating actuation signals for energizing coils of the BLDC drive motor by means of a field-oriented control from a target control torque and the actual angle, wherein:
if the actual rotational speed has not yet reached or exceeded the first threshold rotational speed, the target control torque supplied to the field-oriented control is the deterministic target control torque; and
if the actual rotational speed reaches or exceeds the first threshold rotational speed, the target control torque supplied to the field-oriented control is a manipulated variable of a speed control, whose reference variable corresponds to the target rotational speed and whose feedback variable corresponds to the actual rotational speed.

16. The method according to claim 13, which further comprises generating the deterministic target control torque by means of a signal transmitter.

17. The method according to claim 13, wherein the deterministic target control torque is a constant target control torque.

18. The method according to claim 15 wherein the deterministic target control torque is a chronological progression of the target control torque.

19. The method according to claim 13, wherein the deterministic target control torque is dependent on at least one pressure present in a reciprocating compressor of the household appliance driven by the BLDC drive motor or on a variable derived therefrom.

20. The method according to claim 15, wherein a maximum torque per ampere (MTPA) logic is connected upstream of a field-oriented control logic, and converts the target control torque into a target I_{d} current and a target I_{q} current and transfers them to the field-oriented control logic as input variables.

21. The method according to claim 13, wherein in the idle state of the BLDC drive motor the actual rotational speed of the BLDC drive motor is zero.

22. A household appliance, comprising:
a brushless direct current (BLDC) drive motor;
wherein the household appliance is configured to perform the method according to claim 13.

23. The household appliance according to claim 22, further comprising a reciprocating compressor being driven by means of said BLDC drive motor.

24. The household appliance according to claim 22, wherein the household appliance is a refrigeration appliance.

25. The household appliance according to claim 22, wherein the household appliance is a refrigerator.
